(19) United States
(12) Patent Application Publication
(10) Pub. No.: US 2003/0084685 A1
(43) Pub. Date: May 8, 2003

(54) Method of making an optical fiber or preform having a reduced hydrogen content

(75) Inventor: Richard P. Tumminelli, Ashland, MA (US)

Correspondence Address: ALLEN, DYER, DOPPELT, MILBRATH & GILCHRIST P.A., 1401 CITRUS CENTER 255 SOUTH ORANGE AVENUE, P.O. BOX 3791, ORLANDO, FL, 32802-3791, US

(73) Assignee: JDS Uniphase Corporation, San Jose, CA

(21) Appl. No.: 10/286,302

(22) Filed: Nov. 1, 2002

Related U.S. Application Data
(60) Provisional application No. 60/335,349, filed on Nov. 2, 2001.

(51) Int. Cl. C03B 37/018

(52) U.S. Cl. 65/417; 65/426

(57) ABSTRACT

The invention provides a method of making an optical fiber preform using a modified chemical vapor deposition process by flowing glass precursor gases through a preform tube for depositing glass material therein, and simultaneously flowing heavy water vapors through the preform tube for incorporating deuteroxyl groups into the glass material. Then, the preform tube is controllably heated so as to effect a collapse of the preform tube into a rod. Advantageously, optical fibers drawn from such preforms have an increased resistance to hydrogen and will not require passivation.

### CROSS-REFERENCE TO RELATED APPLICATIONS

This application claims priority of U.S. Provisional Patent Application No. 60/335,349 filed on Nov. 2, 2001, which is incorporated herein by reference for all purposes.

### MICROFICHE APPENDIX

Not Applicable

### FIELD OF THE INVENTION

The present invention generally relates to the field of optical fibers and preforms and in particular to a method of reducing a hydrogen content of an optical fiber or preform.

### BACKGROUND OF THE INVENTION

Optical fibers are typically drawn from glass preforms. An optical fiber preform is generally comprised of an inner core and an outer cladding layer. The inner core, for the most part, has a higher refractive index than the cladding layer. When the preform is drawn into an optical fiber, the difference in refractive indices between the core and cladding layers allows the propagation of the optical signal within the core. Optical fiber preforms and waveguides are composed primarily of high purity silica glass.

Variations in the refractive index are obtained by adding dopants to layers within the central core or surrounding cladding layer. Certain dopants such as the oxides of germanium, aluminum, and phosphorous are added, in a weight percentage typically ranging from about 0.1 to 25%, to increase the refractive index of the glass. Other dopants such as fluorine and boron oxide may be added in similar amounts to decrease the refractive index of the glass. A typical optical fiber glass core composition is comprised mainly of high purity SiO₂ glass, in a weight percentage above 50%, with lesser amounts of GeO₂, and/or other dopants, depending upon the desired optical properties.

Glass optical fiber preform can be made from a variety of processes. Typical processes for making these preforms are variations of chemical vapor deposition (CVD) processes such as Outside Vapor Deposition (OVD), Modified Chemical Vapor Deposition (MCVD), or Vapor Axial Deposition (VAD). These processes typically involve the oxidation of glass precursors, such as metal chlorides, to form glass particulate. Glass precursors, such as silicon tetrachloride (SiCl₄), or germanium tetrachloride (GeCl₄), which may be liquid at room temperature, are heated within bubblers, vaporizers, or similar means to form a metal chloride vapor. Chlorides are widely used because they vaporize at relatively low temperatures prior to transportation to the reaction zone or a hot zone such as a burner flame, plasma, or heated area within a substrate tube. The chloride vapors oxidize within the reaction zone thereby forming a glass particulate. After a sufficient thickness of particulate is reached, the glass particulate eventually forms the porous soot blank. The porous soot blank is then sintered, or heated until the pores are eliminated, to form a glass preform. In the MCVD process, the formation and sintering of the glass particulate generally occurs simultaneously.

There is also a need to produce optical fibers with dopants, such as rare earth halides (e.g. erbium chloride) or aluminum chloride. Doping with rare earth chlorides is performed for the fabrication of rare earth-doped fibers for use in amplifiers.

Special optical fibers are of primary importance in the telecommunications industry. They differ in many ways from standard long haul transmission fibers, as they are designed to perform specific functions for various applications. As stated heretofore, one very important class of special fibers is rare earth doped fibers. The series of rare earth elements have interesting optical properties and are used as an optical gain medium for lasers and amplifiers. When doped into the core of an optical fiber, they provide optical gain for lasing or amplifying applications. In addition, because the gain medium is the core of an optical fiber, there are other benefits. The fibers' core provides tight confinement of the light, higher power density and high overlap of the pump light and the lasing or signal light. All these factors enhance the optical properties of the rare earths. In addition to the fibers' guiding properties, the presence of co-dopants with the rare earth have a significant affect on their performance.

Erbium is of interest because it can provide gain in the low loss window of long haul transmission fiber. Due to the nature of the erbium atom, the gain provided in this window is not flat, rather, it has a particular gain shape which is undesirable. In order to achieve gain flatness, gain-flattening filters are used successfully. One environmental concern for amplifiers that use erbium doped fiber is exposure to hydrogen. Hydrogen can diffuse into the fiber core region where it can react with germanium and silicon defect centers to form OH groups, which cause optical loss in the wavelength region of interest. For erbium doped fiber, this effect can cause the gain shape of the fiber to change and render the gain flattening filter useless for the application.

One way of “passivating” the fiber against this effect is to expose the fiber to deuterium gas at the appropriate pressure and temperature. Deuterium is chemically identical to hydrogen and will diffuse into the fiber and react with available sites to form OD groups just as hydrogen would form OH groups. Deuterium is simply an isotope of hydrogen with the nucleus consisting of one proton and one neutron whereas hydrogen has just one proton. The presence of the deuterium prevents further reaction with hydrogen upon exposure in the field by reacting with all the available sites in the glass. When the fiber is exposed to hydrogen after passivation, the hydrogen will still diffuse into the core, but will not react since there are no available sites left. The reason why deuterium is used for passivation is that the optical loss caused by hydroxyl (OH) groups is shifted to longer wavelengths, out of the region of interest, when deuteroxyl (OD) groups are formed. This is due to the fact that the mass of the deuterium atom is twice that of hydrogen and causes the fundamental OH stretch and its' harmonics to be shifted to longer wavelengths. Accordingly, the OH absorption band at 1.42 μm is shifted to a 1.95 μm OD absorption band which is substantially away from the working wavelength of an erbium-doped fiber amplifier (EDFA). Hence, hydrogen aging or hydrogen-induced loss increases are reduced for such passivated fibers.

However, deuterium gas cannot be introduced during MCVD processes because it will burn inside the tube. This can cause an actual flame that will traverse down the length of the preform tube and interfere with the soot deposition. Furthermore, it is unstable and can cause pressure variations which can cause other undesirable effects.

Hence, it is an object of the invention to manufacture optical fiber preforms and/or fibers having a reduced loss increase upon exposure to hydrogen and/or water.

It is a further object of the invention to provide optical fiber preforms or fibers with a reduced amount of hydroxyl groups.

Another object of this invention is to make rare earth-doped optical fiber preforms having a reduced amount of hydroxyl groups using modified chemical vapor deposition (MCVD).

### SUMMARY OF THE INVENTION

In accordance with the invention there is provided a method of making an optical fiber preform comprising the steps of flowing glass precursor gases through a preform tube for depositing glass material therein; and simultaneously flowing heavy water (D₂O) vapors through the preform tube for incorporating deuteroxyl groups (OD) into the glass material.

In accordance with the present invention, the optical fiber preform is made by modified chemical vapor deposition. Subsequently, optical fibers are drawn from the preform.

In accordance with an embodiment of the invention, the step of flowing glass precursor gases through a preform tube is performed in an oxidizing medium, such as oxygen gas. The step of flowing heavy water vapors is either done in an inert medium or an oxidizing medium. If an oxidizing medium is used, the selected gas is the same as the carrier gas used for flowing the glass precursor gases through the preform tube. If an inert medium is used, the gas is selected from the group consisting of helium, neon, and argon.

In accordance with a further embodiment of the present invention, the glass precursor gases comprise SiO₂, and at least one dopant selected from the group consisting of GeO₂, P₂O₅, B₂O₃, Al₂O₃, and rare earth oxide.

In another embodiment of the present invention, the heavy water vapors (D₂O) are in excess of water vapors (H₂O) for incorporating deuteroxyl groups (OD) into the glass material. An amount of heavy water vapors (D₂O) is controlled by controlling at least one of a vapor pressure of the heavy water (D₂O) and a flow of the heavy water (D₂O) vapors.

In accordance with yet another embodiment of the invention, the method comprises the further step of controllably heating the preform tube after deposition so as to effect a collapse of the preform tube.

In accordance with another aspect of the invention, there is provided, a method of making an optical fiber having a reduced hydrogen content comprising the steps of: a) forming an optical fiber preform comprising the steps of: i) depositing glass material in a preform tube by flowing glass precursor gases therethrough using a first carrier gas; and ii) simultaneously incorporating deuterium into the glass material by flowing heavy water vapors (D₂O) through the preform tube using a second carrier gas; and b) drawing said optical fiber preform into an optical fiber.

In accordance with a further embodiment of the invention, the amount of heavy water vapors (D₂O) is controlled by controlling at least one of a vapor pressure of the heavy water (D₂O), a pressure in the preform tube, and a flow rate of the carrier gas of the heavy water vapors.

In accordance with the invention, there is further provided, a method of making an optical fiber preform having a reduced amount of hydroxyl groups (OH) for reducing hydrogen induced losses comprising the steps of: depositing glass material in a preform tube by flowing glass precursor gases therethrough; exchanging at least a portion of hydroxyl groups of the glass material with deuteroxyl groups by flowing heavy water vapors through the preform tube; and heating the preform tube in a controlled manner so as to effect a collapse of the preform tube.

In another embodiment of the invention, the flow of the glass precursor gases and the heavy water vapors is constant and continuous so as to ensure a uniform deposition of the glass material.

Advantageously, the present invention provides optical fiber preforms or fibers with a reduced amount of hydroxyl groups. Furthermore, the present invention provides a method for making rare earth-doped optical fiber preforms having a reduced amount of hydroxyl groups using modified chemical vapor deposition (MCVD). In doing so, a flow heavy water is delivered into the MCVD reaction zone during fiber preform fabrication. Advantageously, optical fibers drawn from such preforms have an increased resistance to hydrogen and will not require passivation.

### BRIEF DESCRIPTION OF THE DRAWINGS

Exemplary embodiments of the invention will now be described in conjunction with the following drawings wherein like numerals represent like elements, and wherein:

FIG. 1 shows prior art data that illustrate the large difference between conventional silica-based fiber and rare earth-doped fiber with regard to their susceptibility to hydrogen-induced loss increase;

FIG. 2 shows exemplary prior art data on hydrogen-induced loss increase as a function of wavelength;

FIG. 3 shows a diagram of a prior art MCVD apparatus useful in practicing the invention; and

FIG. 4 presents a schematic flow diagram showing a chemical vapor delivery system in accordance with the present invention.

### DETAILED DESCRIPTION OF THE PREFERRED EMBODIMENTS

Erbium-doped fibers were shown to have a sensitivity to hydrogen which is accelerated by both, temperature and partial pressure of hydrogen; M. J. LuValle et al., “Kinetic modeling of hydrogen induced degradation in erbium doped fiber amplifiers”, SPIE Vol. 3848, pp. 260-270, Part of the SPIE Conference on Optical Fiber Reliability and Testing, Boston, Mass., September 1999. As disclosed by Jin et al. in U.S. Pat. No. 5,274,734, silica-based optical fibers that are doped with Ge, Al and a rare earth (e.g., Er) can be susceptible to hydrogen-induced attenuation change. Jin et al. state that such fiber can exhibit loss increase rates that are, at 20° C., 10⁶ times larger than those of a standard single mode fiber. Further, they suggest that transition metal-doped silica-based fibers can exhibit large hydrogen-induced attenuation change. In many circumstances (e.g., amplifier fiber, attenuator fiber) a significant attenuation change of optical fiber is undesirable.

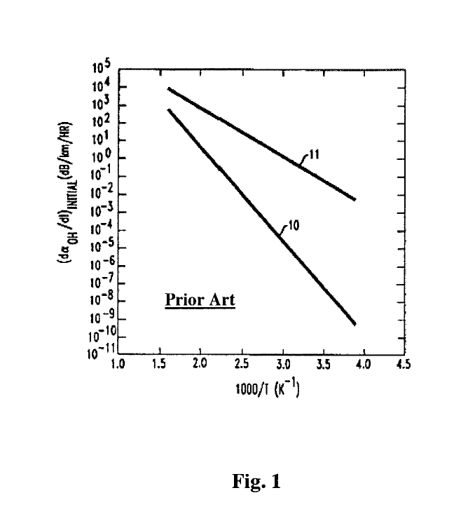

FIG. 1 shows prior art data of (dα_{OH}/dt)ᵢₙᵢₜᵢₐₗ (the initial rate of fiber loss increase due to OH in the fiber) vs. inverse absolute temperature as presented in U.S. Pat. No. 5,274,734 incorporated herein by reference. The initial rate is a known measure of the susceptibility of a fiber to hydrogen-induced loss. See, for instance, A. Tomita & P. J. Lemaire, “Hydrogen-Induced Loss Increases in Germanium-Doped Single-Mode Optical Fibers: Long-Term Predictions”, Electronics Letters, Jan. 17, 1985, Vol. 21, No. 2, pp. 71-72, incorporated herein by reference. The data were obtained by exposing conventional single mode transmission fibers (5 D fiber available from AT&T; curve 10) and single mode Er-doped amplifier fiber (core doping 18% GeO₂; 2% Al₂O₃ and 200 ppm Er; curve 11) to 1 atmosphere of H₂ at various temperatures, and measuring the rate of fiber loss increase at λ≈1.4 μm. FIG. 1 shows that at 70° C., the initial rate of increase of the 5 D and Er-doped fibers is about 10⁻⁴ and 3 dB/km hour, respectively, and at 7° C., it is about 3×10⁻⁸ and 6×10⁻² dB/km·hour, respectively. FIG. 1 thus clearly demonstrates the huge difference in the susceptibility to hydrogen-induced loss between Ge-doped conventional transmission fiber and Er-doped amplifier fiber, especially at expected operating temperatures (e.g., 3°-70° C.).

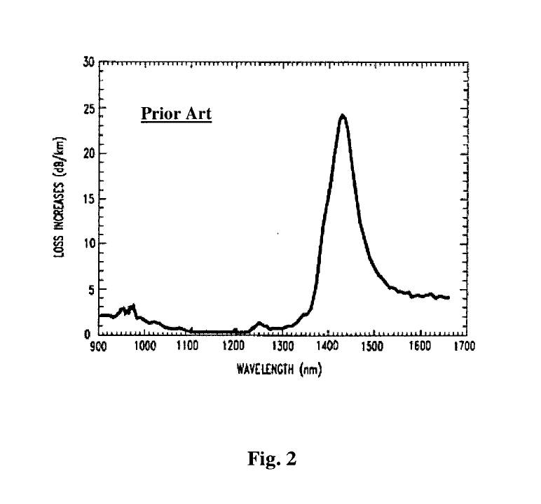

FIG. 2 shows a hydrogen-induced loss increase in an Er-doped silica-based fiber after 24 hours at 213° C. in 10⁻⁴ atmospheres of H₂, as disclosed in U.S. Pat. No. 5,274,734. The fiber did not have its hydroxyl sites (OH) exchanged with deuteroxyl sites (OD), and hence quickly depleted by reaction with hydrogen. The main loss peak at about 1.43 μm is believed to be due to the formation of OH in the fiber core. It is to be noted that this peak causes significant loss increase at 1.48 μm (a possible pump wavelength for Er-doped fiber amplifiers) and at 1.55 μm (a likely signal wavelength).

The present invention provides a method of fabricating an optical fiber preform having a reduced number of hydroxyl groups by deuterating the hydroxyl groups of the preform using heavy water vapors under formation of deuteroxyl groups. An optical fiber is then subsequently drawn from the preform that is resistent to hydrogen-induced loss and does not require a subsequent passivation step to reduce optical losses due to hydrogen. The preform is fabricated using the method of modified chemical vapor deposition (MCVD).

The MCVD process consists of formation and deposition of glass soot on an inner surface of a glass substrate tube. The deposited glass forms the core region and a part of the cladding region (“matched cladding”), with the largest part of the cladding being made up of the original substrate tube.

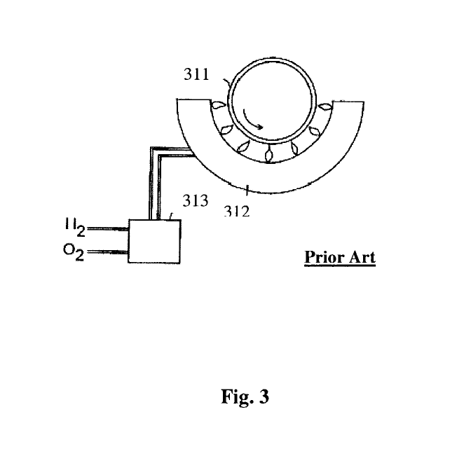

The basic MCVD process is well known, as is the equipment used in the process. See for example, J. B. MacChesney et al., “Preparation of Low Loss Optical Fibers Using Simultaneous Vapor Phase Deposition and Fusion”, Xth Int. Congress on Glass, Kyoto, Japan (1973) 6-40. As seen in FIG. 3, the silica tube 311 is mounted for rotation in an MCVD glass lathe (not shown). Glass precursor gases, e.g. SiCl₄, GeCl₄, O₂, are passed down the rotating tube while the tube is heated with an oxy-hydrogen torch 312. When deposition and consolidation are complete the tube is collapsed by known techniques, i.e. heating the tube to well above the glass softening temperature, i.e. >2000-2400° C. to allow the surface tension of the glass tube to slowly shrink the tube diameter, finally resulting, after multiple passes of the torch, in the desired solid preform. The temperature of the torch is controlled by the ratio of hydrogen to oxygen, and their absolute flow rates in the fuel mixture supplied to the torch. The gas flow control, shown at 313 in FIG. 3, controls the flow rate of hydrogen and oxygen independently, and thus the ratio of hydrogen to oxygen, and the resulting metered gas streams are supplied to the torch 312. The gases are mixed at the flame according to well known techniques.

In the MCVD process, the last several deposited soot layers are typically silica (SiO₂) doped with GeO₂, the latter for increasing the refractive index of the silica in the core of the preform. The silica tube collapse is conducted at very high temperatures, sufficient to soften the silica glass and allow the tube to collapse in a controlled fashion under the influence of surface tension on the glass surface.

In the MCVD process, described for example in “An Overview of the Modified Chemical Vapor Deposition (MCVD) Process and Performance”, IEEE Jour. Quantum Elec., Vol QE-18, No. 4, April 1982, a preform substrate tube comprised of pure fused silica, SiO₂, is mounted on a glass-working lathe. The tube is held at both ends in the lathe chucks and fitted at one end with a rotation seal assembly which allows the delivery of glass precursor chemicals to the inside of the tube.

The glass and dopant forming precursor gases/chemicals are delivered to the inside of the tube through the rotating seal. The precursors come from a chemical vapor delivery system which consists of temperature controlled vessels with the liquid precursor chemicals inside. Typical chemicals for forming the glass precursor gases are SiCl₄, GeCl₄ and POCl₃, BBr₃, which are liquids at room temperature. A carrier gas, typically oxygen, is bubbled through the liquid, which vaporizes the material and carries it to the tube on the lathe. The flow rate of carrier gas, the temperature of the liquid precursor, and the total pressure of the system control the amount of material delivered to the tube. In order to deposit a layer of material inside the tube, the tube is rotated and brought to a predetermined temperature. As the chemical precursors flow to the hot zone, heated from the outside by the burner, they react to form oxides in the form of soot that travel down the tube and are deposited downstream.

If desired, other precursor materials, such as rare earth halides (e.g. erbium chloride), BCl₃, and AlCl₃ are also used for doping during the preform fabrication.

The burner carriage is made to traverse at a predetermined speed, which accomplishes two tasks. First, it forms more soot as it travels, the soot depositing further downstream from the hot zone, and, it sinters the soot that has already been deposited into a uniform glass layer. As the torch traverses the entire length of the tube (a “pass”), a layer of glass material is deposited. Typically, a plurality of passes is made to deposit layers of glass with the desired composition. The composition can be changed by adjusting the carrier flow rates and/or the precursor temperatures. An example of the parameters used for a typical pass: precursor temperatures held at 20° C., SiCl₄ carrier flow rate=500 sccm, GeCl₄ carrier flow rate=200 sccm, POCl₃ carrier flow rate=100 sccm, tube temperature=1700° C., carriage traverse speed=100 mm/min, and inside tube pressure=2 mbar. This set of conditions would deposit glass at the rate of between 0.3 and 0.4 grams/minute. The total number of passes would be determined by how large a core deposition or core/cladding deposition is desired. The composition can be varied per pass, thereby altering the refractive index of the deposited material or altering other characteristics.

The process may include deposition of a so-called matched cladding, a concept known in the art. Typically, the equivalent of 2 to 3 core diameters of cladding is deposited. After deposition of the core and the matched cladding layers, the tube is collapsed to form a solid rod i.e. the preform. This is accomplished by increasing the temperature of the tube and subjecting the tube to a plurality of torch passes at the higher temperature, typically between 2000 and 2100° C. At this higher temperature, the stiff substrate tube becomes soft and shrinks in size, pass after pass, until it collapses to a solid rod.

In the MCVD process, great care is taken to eliminate water from the reaction zone, as the presence of water causes incorporation of OH groups in the glass, which can cause high optical loss. Not all preform manufacturing processes use this approach. For example, the optical vapor deposition (OVD) process and the vapor axial deposition (VAD) process inherently make “wet glass” due to the nature of the process. In order to remove the OH groups, the unsintered preform is exposed to chlorine (Cl₂) gas at a specific temperature and for a specific time. The Cl₂ diffuses into the glass, reacts with the hydrogen to form HCL which diffuses back out of the glass. This can only happen when the glass is in its' “soot” form as the diffusion distances are on the order of sub-micron. After consolidation, the OH content of the glass will be fixed. In the MCVD process, consolidation takes place almost immediately and there is no time for a Cl₂ drying step. Therefore, it is very important to keep the water out of the process. There is, however, Cl₂ present in the reaction zone, formed as a reaction product during the oxidation of SiCl₄ and GeCl₄. In addition, Cl₂ gas can be metered into the reactant gas stream if desired. If water is present, some will be incorporated into the glass, however, most of it will be carried away as HCL from the presence of the Cl₂. Thus, in accordance with the present invention, a carrier gas, such as helium (He), is purposely bubbled through a bubbler containing heavy water (D₂O). Controlling the flow of the carrier gas and the temperature of the bubbler can control the amount of heavy water carried into the hot zone. Hence, the amount of D₂O in the hot zone is far greater than H₂O from other sources and the greatest percentage of incorporation into the glass will be D₂O. The deuterium will passivate all the available sites during the preform fabrication. Fiber drawn from this preform will not require passivation as the “as drawn” fiber will be resistant to changes in gain from exposure to hydrogen.

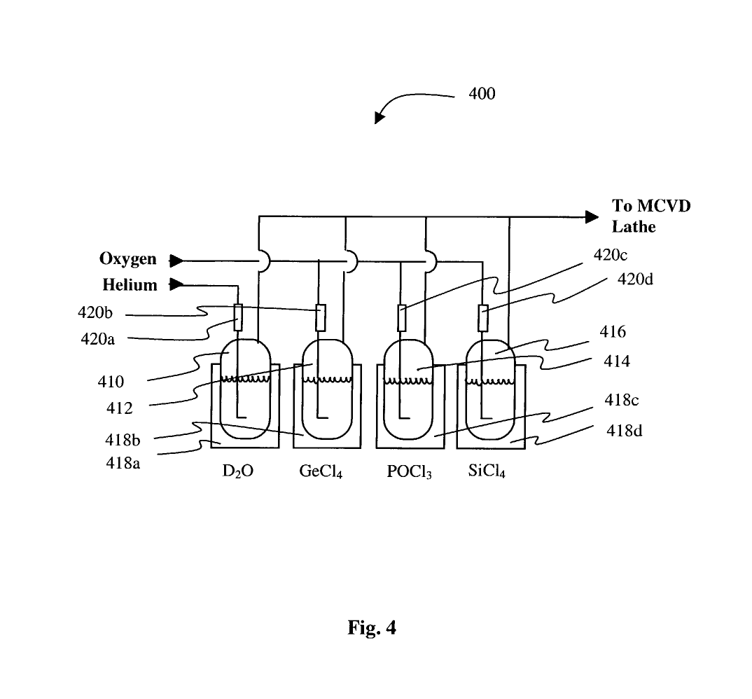

Turning now to FIG. 4, a schematic flow diagram is presented, showing a chemical vapor delivery system 400 in accordance with the present invention including an additional bubbler 410 for heavy water. An inert gas, such as helium, neon, or argon, is used as a carrier gas and bubbled through the heavy water bubbler 410 to deliver heavy water vapors to the MCVD lathe (not shown). The vapor delivery system 400 further includes a GeCl₄ bubbler 412, a POCl₃ bubbler 414, and an SiCl₄ bubbler 416. The heavy water bubbler 410, the GeCl₄ bubbler 412, the POCl₃ bubbler 414, and the SiCl₄ bubbler 416 further includes respective temperature controllers 418a-d, and mass flow controllers 420a-d. The glass precursor gases are delivered to the lathe in an oxidizing medium by means of an oxidizing carrier gas, such as oxygen.

In accordance with an embodiment of the present invention, an amount of the heavy water vapors is selected such that there is an excess of heavy water vapors (D₂O) in comparison to water vapors (H₂O) to ensure the incorporation of deuteroxyl groups into the glass material. An excess of heavy water vapors favors the incorporation of deuterium into the glass material over hydrogen. Heavy water vapors are delivered to the deposition zone by bubbling a carrier gas through the heavy water bubbler. Furthermore, an amount of water vapors in the deposition is reduced by limiting the diffusion of atmospheric water into the system. The amount of material of glass precursor gases or heavy water vapors that is delivered to the deposition zone is a function of the vapor pressure of the material, which is a function of temperature, the total pressure of the system, and the carrier gas flow rate. This will be explained in more detail below.

In accordance with another embodiment of the invention, the flow of glass precursor gases and heavy water vapors is maintained at a constant and continuous flow rate during the deposition process in order to ensure a uniform deposition of the glass material.

### EXAMPLES

Typical deposition temperature is between 1600° C. and 1800° C. Typical pressure inside the tube is approximately 1 to 2 inches of water. The bubblers are held at 20° C., however, this could go as high as 40° C. if necessary.

The following exemplary calculation shows that if only 10 sccm of helium are bubbled through a D₂O bubbler at 20° C., this would carry approximately 1 E-5 moles/min to the hot zone. This is approximately 6E18 molecules of D₂O carried to the hot zone per minute. The total flow of all gases to the hot zone is about 2 liters/min or about 5E22 molecules/min. The mole fraction of D₂O in the hot zone would be about 1E-4. Typically, the gases are kept very dry. They come from cryogenic sources, and molecular sieve dryers are used to dry them, and precaution is taken to keep atmospheric water out of the deposition zone. The dew point is well below −100° C. Assuming that the dew point of the gases is −80° C., the vapor pressure of water is about 0.1 Pa or 0.00075 mmHg. This translates to a mole fraction of H₂O of about 1E-6 in the gases delivered to the hot zone. This a approximately 2 orders of magnitude lower than the D₂O that would be present. Therefore, a flow of between 5 and 10 sccm of He through a D₂O bubbler at 20° C. should be sufficient.

The above described embodiments of the invention are intended to be examples of the present invention and numerous modifications, variations, and adaptations may be made to the particular embodiments of the invention without departing from the spirit and scope of the invention, which is defined in the claims.

What is claimed is:

1. A method of making an optical fiber preform comprising the steps of:
a) flowing glass precursor gases through a preform tube for depositing glass material therein; and
b) simultaneously flowing heavy water (D₂O) vapors through the preform tube for incorporating deuteroxyl groups (OD) into the glass material.

2. The method as defined in claim 1 wherein the optical fiber preform is made by modified chemical vapor deposition.

3. The method as defined in claim 2 wherein step a) is performed in an oxidizing medium.

4. The method as defined in claim 3 wherein the oxidizing medium is oxygen gas.

5. The method as defined in claim 2 wherein step b) is performed in an inert medium or an oxidizing medium.

6. The method as defined in claim 5 wherein the inert medium is a gas selected from the group consisting of helium, neon, and argon, and the oxidizing medium is oxygen gas.

7. The method as defined in claim 2 wherein the glass precursor gases comprise SiO₂, and at least one dopant selected from the group consisting of GeO₂, P₂O₅, B₂O₃, Al₂O₃, and rare earth oxide.

8. The method as defined in claim 2 wherein the heavy water vapors (D₂O) are in excess of water vapors (H₂O) for incorporating deuteroxyl groups (OD) into the glass material.

9. The method as defined in claim 8 wherein an amount of heavy water vapors (D₂O) is controlled by controlling at least one of a vapor pressure of the heavy water (D₂O) and a flow of the heavy water (D₂O) vapors.

10. The method as defined in claim 1 further comprising the step of controllably heating the preform tube after performing steps a) and b) so as to effect a collapse of the preform tube.

11. A method of making an optical fiber having a reduced hydrogen content comprising the steps of:
a) forming an optical fiber preform comprising the steps of:
i) depositing glass material in a preform tube by flowing glass precursor gases therethrough using a first carrier gas; and
ii) simultaneously incorporating deuterium into the glass material by flowing heavy water vapors (D₂O) through the preform tube using a second carrier gas; and
b) drawing said optical fiber preform into an optical fiber.

12. The method as defined in claim 11 wherein step a) is performed by modified chemical vapor deposition.

13. The method as defined in claim 12 wherein the first carrier gas is oxygen.

14. The method as defined in claim 13 wherein the first carrier gas is the same as the second carrier gas.

15. The method as defined in claim 12 wherein the second carrier gas is an inert gas.

16. The method as defined in claim 12 wherein an amount of heavy water vapors (D₂O) is selected to be in an excess of water vapors (H₂O) so as to favor the incorporation of deuterium (D) into the glass material over hydrogen (H).

17. The method as defined in claim 16 wherein the amount of heavy water vapors (D₂O) is controlled by controlling at least one of a vapor pressure of the heavy water (D₂O), a pressure in the preform tube, and a flow rate of the second carrier gas.

18. A method of making an optical fiber preform having a reduced amount of hydroxyl groups (OH) for reducing hydrogen induced losses comprising the steps of:
depositing glass material in a preform tube by flowing glass precursor gases therethrough;
exchanging at least a portion of hydroxyl groups of the glass material with deuteroxyl groups by flowing heavy water vapors through the preform tube; and
heating the preform tube in a controlled manner so as to effect a collapse of the preform tube.

19. The method as defined in claim 18 wherein an amount of heavy water vapor is selected to be in an excess of water vapor in the preform tube such that deuteroxyl groups are incorporated into the glass material rather than hydroxyl groups.

20. The method as defined in claim 19 wherein the glass precursor gases comprise SiO₂, and at least one dopant selected from the group consisting of GeO₂, P₂O₅, B₂O₃, Al₂O₃, and rare earth oxide.
